(19) United States
(12) Patent Application Publication
(10) Pub. No.: US 2007/0245375 A1
(43) Pub. Date: Oct. 18, 2007

(54) Method, apparatus and computer program product for providing content dependent media content mixing

(75) Inventors: Jilei Tian, Tamere (FI); Jani Nurminen, Lempaala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/385,578

(22) Filed: Mar. 21, 2006

(51) Int. Cl. H04N 5/445; H04N 7/10; H04N 7/025

(52) U.S. Cl. 725/45; 725/34; 725/35

(57) ABSTRACT

A method of providing content dependent media content mixing includes automatically determining an emotional property of a first media content input, determining a specification for a second media content in response to the determined emotional property, and producing the second media content in accordance with the specification.

### FIELD OF THE INVENTION

Embodiments of the present invention relate generally to mobile terminal technology and, more particularly, relate to a method, apparatus, and computer program product for providing content dependent media content mixing.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many applications, it is necessary for the user to receive audio information such as oral feedback or instructions from the network. An example of such an application may be paying a bill, ordering a program, receiving driving instructions, etc. Furthermore, in some services, such as audio books, for example, the application is based almost entirely on receiving audio information. It is becoming more common for such audio information to be provided by computer generated voices. Accordingly, the user's experience in using such applications will largely depend on the quality and naturalness of the computer generated voice. As a result, much research and development has gone into improving the quality and naturalness of computer generated voices.

One specific application of such computer generated voices that is of interest is known as text-to-speech (TTS). TTS is the creation of audible speech from computer readable text. TTS is often considered to consist of two stages. First, a computer examines the text to be converted to audible speech to determine specifications for how the text should be pronounced, what syllables to accent, what pitch to use, how fast to deliver the sound, etc. Next, the computer tries to create audio that matches the specifications.

With the development of improved means for delivery of natural sounding and high quality speech via TTS, there has come a desire to further enhance the user's experience when receiving TTS output. Accordingly, one way to improve the user's experience is to deliver background music that is appropriate to the text being delivered via an audio mixer. In this regard, background music may be considered appropriate to the text if the background music conveys the same mood or emotional qualities as the associated text with, for example, upbeat music being played in the background for text that conveys a positive or uplifting message. This is especially enhancing for gaming experiences and audio books, for example. However, the effect can be equally enhancing for short messages, emails, and other applications as well. Currently, methods for mixing music and TTS involve embedding explicit tags into the text through manual effort. The text is examined and tags for particular sound effects are inserted. Each sound effect is treated as an independent track with an independent timeline, volume and sample rate. Accordingly, a large amount of storage space is required to store such information. Although either the user or creator of the text may perform the tagging, a time consuming and laborious process results since each command such as Mix, Play, Stop, Pause, Resume, Loop, Fade, etc., must be manually inserted. Furthermore, the music is sometimes not appropriately selected for the mood or emotion of a particular content section. Thus, a need exists for providing a user with the ability to enjoy music that is tailored to a particular text automatically, and without a requirement for such significant effort.

### BRIEF SUMMARY OF THE INVENTION

A method, apparatus and computer program product are therefore provided that allows automatic content dependent music mixing. Additionally, the music mixing does not require embedded tags, thereby reducing memory requirements and, more importantly, eliminating the laborious process of tag insertion. Furthermore, the music is selected or generated responsive to the emotion expressed in the text.

In one exemplary embodiment, a method of providing content dependent media content mixing is provided. The method includes automatically determining an emotional property of a first media content input, determining a specification for a second media content in response to the determined emotional property, and producing the second media content in accordance with the specification.

In another exemplary embodiment, a computer program product for providing content dependent media content mixing is provided. The computer program product includes at least one computer-readable storage medium having computer-readable program code portions stored therein. The computer-readable program code portions include first, second and third executable portions. The first executable portion is for automatically determining an emotional property of a first media content input. The second executable portion is for determining a specification for a second media content in response to the determined emotional property. The third executable portion is for producing the second media content in accordance with the specification.

In another exemplary embodiment, a device for providing content dependent media content mixing is provided. The device includes a first module and a second module. The first module is configured to automatically determine an emotional property of a first media content input. The second module configured to determine a specification for a second media content in response to the determined emotional property and produce the second media content in accordance with the specification.

In another exemplary embodiment, a mobile terminal for providing content dependent media content mixing is provided. The mobile terminal includes an output device, a first module and a second module. The first module is configured to automatically determine an emotional property of a first media content input. The second module configured to determine a specification for a second media content in response to the determined emotional property and produce the second media content in accordance with the specification.

In an exemplary embodiment, the first module is a text content analyzer and the first media content is text, while the second module is a music module and the second media content is musical content.

Embodiments of the invention provide a method, apparatus and computer program product for providing content dependent music mixing for a TTS system. As a result, users may enjoy automatically and appropriately selected music associated with a particular textual content based on the mood, expression or emotional theme of the particular textual content.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a mobile terminal according to an exemplary embodiment of the present invention;

FIG. 4 illustrates an graph of time-varying mixing gain according to an exemplary embodiment of the present invention; and

FIG. 5 is a block diagram according to an exemplary method of providing content dependent music mixing.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

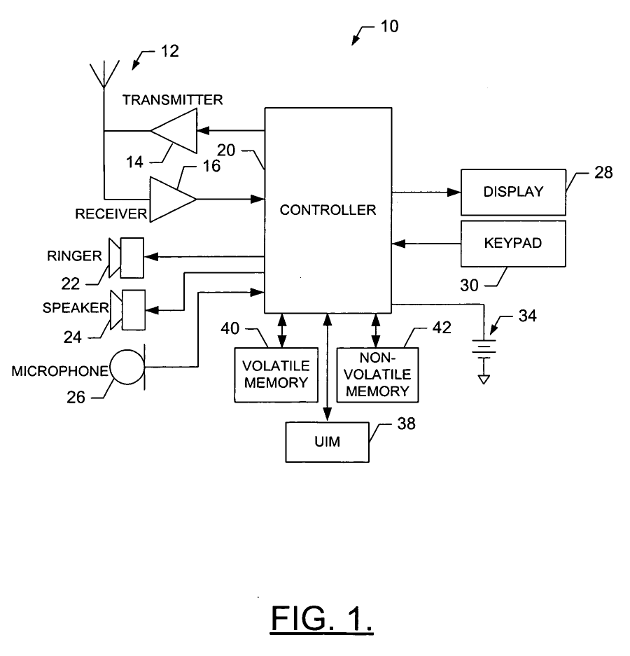

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example. Also, for example, the controller 20 may be capable of operating a software application capable of analyzing text and selecting music appropriate to the text. The music may be stored on the mobile terminal 10 or accessed as Web content.

The mobile terminal 10 also comprises a user interface including an output device such as a conventional earphone or speaker 22, a ringer 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a universal identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

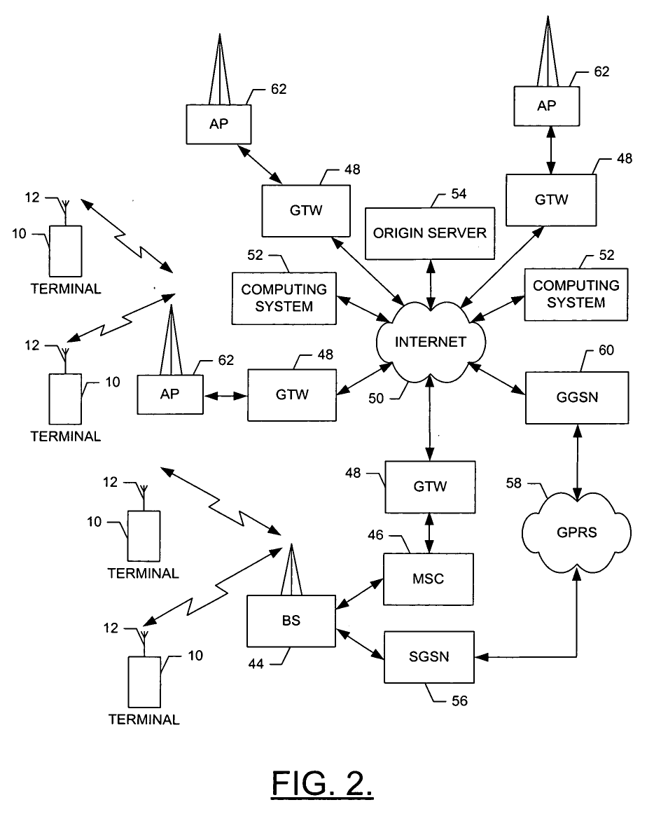

Referring now to FIG. 2, an illustration of one type of system that would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

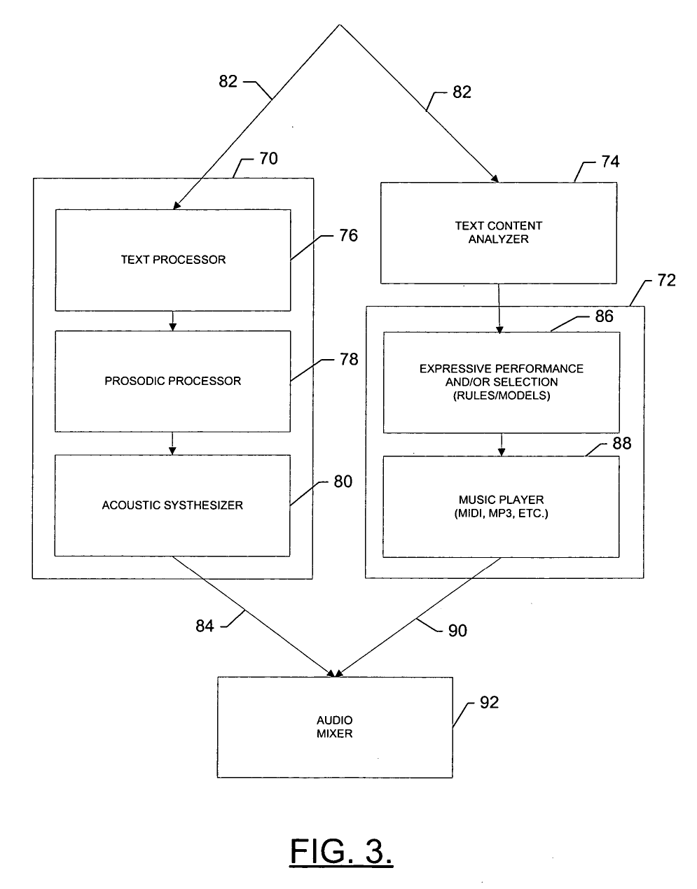

An exemplary embodiment of the invention will now be described with reference to FIG. 3, in which certain elements of a system for content dependent expressive music mixing are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. It should also be noted, however, that while FIG. 3 illustrates one example of a configuration of a system for content dependent expressive music mixing, numerous other configurations may also be used to implement the present invention. Furthermore, although FIG. 3 shows a text-to-speech (TTS) module, the present invention need not necessarily be practiced in the context of TTS, but instead applies more generally to delivering information, in a first media, that is related to the emotional content of information delivered simultaneously in a second media.

Referring now to FIG. 3, a system for content dependent expressive music mixing is provided. The system includes a TTS module 70, a music module 72 and a text content analyzer 74. Each of the TTS module 70, the music module 72 and the text content analyzer 74 may be any device or means embodied in either hardware, software, or a combination of hardware and software. In an exemplary embodiment, the TTS module 70, the music module 72 and the text content analyzer 74 are embodied in software as instructions that are stored on a memory of the mobile terminal 10 and executed by the controller 20.

The TTS module 70 may be any means known in the art for producing synthesized speech from computer text. As such, elements of the TTS module 70 of FIG. 3 are merely exemplary and the descriptions provided below are given merely to explain an operation of the TTS module 70 in general terms for the sake of clarity. The TTS module 70 includes a text processor 76, a prosodic processor 78 and an acoustic synthesizer 80. The text processor 76 receives a media input, such as an input text 82, and begins processing the input text 82 before communicating processed text to the prosodic processor 78. The text processor 76 can perform any of numerous processing operations known in the art. The text processor 76 may include a table or other means to correlate a particular text word or sequence of letters with a particular specification or rule for pronunciation. The prosodic processor 78 analyzes the processed text to determine specifications for how the text should be pronounced, what syllables to accent, what pitch to use, how fast to deliver the sound, etc. The acoustic synthesizer 80 produces a synthetically created audio output in the form of computer generated speech. The acoustic synthesizer 80 applies stored rules or models to an input from the prosodic processor 78 to generate synthetic speech 84 that audibly reproduces the computer text in a way that conforms to the specifications determined by the prosodic processor 78. The synthetic speech 84 may then be communicated to an output device such as an audio mixer 92 for appropriate mixing prior to delivery to another output device such as the speaker 22.

The text content analyzer 74 divides the input text 82 into segments. The segments may correspond to, for example, paragraphs or chapters. Alternatively, the segments may correspond to arbitrarily chosen portions of text. The text content analyzer 74 then analyzes each of the segments by applying natural language processing. Using the natural language processing, the text content analyzer 74 identifies portions of the input text 82 that correspond to certain emotions or certain types of expressiveness. Portions of the input text 82 corresponding to certain emotions or types of expressiveness are then marked, labeled, tagged, or otherwise identified by the text content analyzer 74 to identify the text portions with emotions or expressions that correspond. In this way, an emotional property of each of the segments may be determined.

The natural language processing may be performed, for example, by use of a key word search. For example, words such as sad, somber, sorrowful, unhappy, etc. may correlate to an emotion of sadness. The natural language processing may alternatively be performed, for example, by using a pre-trained statistical model. The model may include tables or other means for dividing specific words, combinations of words, or words within proximity to each other into particular emotional groups. In an exemplary embodiment, text portions may be classified as belonging to one of four basic emotions such as anger, sadness, happiness and fear. More sophisticated classifications may also be implemented including additional emotions such as, for example, excitement, drama, tension, etc. Accordingly, each of the segments may be analyzed by comparison to the table of the model. In an exemplary embodiment, a probabilistic determination may be made by an algorithm that determines which entry in the table with which a particular segment most closely corresponds. The tables include, for example, words, combinations of words, and words in proximity to each other which are often associated with a particular emotional property. Accordingly, a phrase such as “I find that it is increasingly rare that I feel happy”, could be associated with sadness, rather than with happiness as may occur with a simple word search for “happy”.

In an exemplary embodiment, a user of the mobile terminal 10 may manually supplement the automatic processing of the text content analyzer 74. In such a situation, the user may manually tag particular text segments and associate a desired emotion with that text segment. For example, the user may select a text portion using a click and drag operation and select the desired emotion from or input the desired emotion into a dialog box. Furthermore, the user may have the option to bypass the text content analyzer 74 completely and perform all associations between text segments and corresponding emotions manually.

The music module 72 includes an expressive performance and/or selection module 86 and a music player 88. The expressive performance and/or selection module 86 employs particular rules or models to control playback of sounds and/or music that correlates to the emotion or expression associated with each of the text segments as determined by the text content analyzer 74. The expressive performance and/or selection module 86 then sends instructions to the music player 88. The music player 88 plays music according to the instructions generated by the expressive performance and/or selection module 86. The instructions may include a command to play, for example, a stored MP3 or a stored selection of musical notes. The stored MP3 or the stored selection of musical notes may be associated with a particular emotion or expression. Thus, the text content analyzer 74 may associate a particular emotion with a text segment based on the natural language and the expressive performance and/or selection module 86 will send instructions to the music player 88 to cause the music player 88 to play or generate music that is associated with the particular emotion or expression. In an exemplary embodiment the music player 88 may employ the well known technology of musical instrument digital interface (MIDI). However, other suitable technologies for playing music may also be employed, such as MP3 or others. Accordingly, the music player 88 outputs music content 90 that is associated with a particular emotion, mood or expression. The music content 90 may then be communicated to an output device such as the audio mixer 92 for mixing with the synthetic speech 84. Alternatively, the music content 90 may be stored prior to communication to the output device. Additionally, mixing may occur somewhere other than at the output device.

The expressive performance and/or selection module 86 may, in one exemplary embodiment, select background music or sound that is appropriate to the text based on results from the text content analyzer 74. In this regard, a list of available music elements may be stored either in the memory of the mobile terminal 10 or at a network server that may be accessed by the mobile terminal 10. The list of available music elements may have each musical element (or piece) classified according to different emotions or expressions. In an exemplary embodiment, text content analyzer 74 may classify text according to a set of various emotional themes and the expressive performance and/or selection module 86 may access musical elements that are classified by the same set of various emotional themes to select a musical element that is appropriate to the emotional theme of a particular text section as determined by the text content analyzer 74. The musical elements associated with each of the emotional themes may be predetermined at the network by a network operator and updated or changed as desired or required during routine server maintenance. Alternatively, the user may manually select musical elements that the user wishes to associate with each of the emotional themes. Selections for a particular user may be stored locally in the memory of the mobile terminal 10, or stored remotely at a network server, i.e., as a part of the user's profile. In an exemplary embodiment, a series of musical selections, stored in MP3 form, and classified according to emotional theme may be stored on either the memory of the mobile terminal 10 or at a network server. The mobile terminal 10 then automatically associates text segments with particular ones on the musical selections for mixing of synthetic speech from the text segments with corresponding musical selections that have an emotional theme associated with each of the text segments.

In another exemplary embodiment, the expressive performance and/or selection module 86 may generate music that is intelligently selected to correspond to the emotional theme determined by the text content analyzer 74. For example, the expressive performance and/or selection module 86 may present a musical piece with specific content-dependent emotional coloring. In other words, although the musical piece, which is essentially a collection of musical notes, is normally rendered as generically described by a composer of the musical piece, the present invention provides a mechanism by which the emotional theme determined by the text content analyzer 74 may be used to modify the musical piece in accordance with the determined emotional theme. As such, notes in the musical piece or score are rendered in terms of, for example, intensity, duration and timbre in a way that expresses the determined emotional theme. In other words, the expressive performance and/or selection module 86 is capable of adding expressive or emotional content to the score by rendering the score modified according to the determined emotional theme.

The expressive performance and/or selection module 86 may be programmed to perform the addition of expressive or emotional content to the score by any suitable means. For example, case based reasoning systems, multiple regression analysis algorithms, spectral interpolation synthesis, rule based systems, fuzzy logic-based rule systems, etc. may be employed. Alternatively, analysis-by-measurement to model musical expression and the extraction of rules from performances by a machine learning system may also be employed. In an exemplary embodiment, the expressive performance and/or selection module 86 provides at least one specification based on emotion determined from a text to the music player 88 along with a musical element. The music player 88 then produces musical content responsive to the specification and the musical element. Accordingly, pre-composed music may be stored in note form on either the memory of the mobile terminal 10 or at a network server and played in different ways by the music player 88, dependent upon a mood or emotion determined from the text. In an exemplary embodiment, the pre-composed music may be predetermined according to the text (i.e., a musical score associated with a particular book title) or pre-selected by the user. For example, the user may select the works of Bach or Handel to be modified according to the emotion determined from the text. Alternatively, the pre-composed music may be selected from a playlist determined by, for example, the user, a network operator or a producer of an electronic book.

Thus, the expressive performance and/or selection module 86 either selects, generates, or modifies music based on text content analysis, thereby producing music that matches an emotional or expressive coloring of the text content. In other words, for example, the expressive performance and/or selection module 86 may select music that is predefined to correlate to a particular emotion or expression responsive to the emotional or expressive coloring of the text content. Alternatively, the expressive performance and/or selection module 86 may modify selected music (i.e., change notes, instruments, tempo, etc.) to correlate an expression or emotion of the music with the emotional or expressive coloring of the text content. The music player 88 then plays the music that is either selected, generated or modified by the expressive performance and/or selection module 86. It should be noted that although the expressive performance and/or selection module 86 and the music player 88 are shown as separate elements in FIG. 3, the expressive performance and/or selection module 86 and the music player 88 may be combined into a single element capable of performing all of the functions described above. It should also be noted that although the text content analyzer 74 and the text processor 76 are shown as separate elements in FIG. 3, the text content analyzer 74 and the text processor 76 may be combined into a single element capable of performing all of the functions described above.

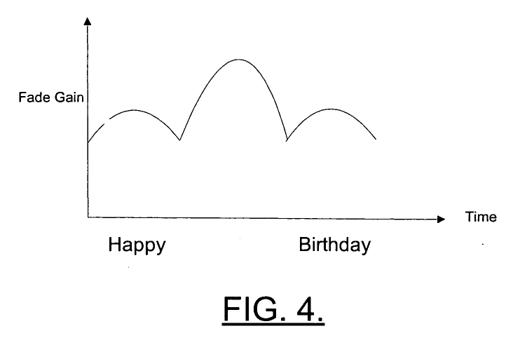

The audio mixer 92 is any known device or means, embodied in software, hardware or a combination of hardware and software, which is capable of mixing two audio inputs to produce a resultant output or combined signal. In an exemplary embodiment, the audio mixer 92 generates a combined signal x(n) by mixing synthetic speech s(n) and background music/sound mᵢⱼ(n). Accordingly, the combined signal x(n) may be described by the equation: x(n)=s(n)+α(n)*mᵢⱼ(n), in which α denotes time-varying mixing gain and i and j are the i^{th} expressive mode of j^{th} selected music. In a TTS system, prosodic parameters include pitch, duration, intensity, etc. Accordingly, based on the parameters, energy and word segmentation values may be defined. The synthetic speech to background music ratio (SMR) may then be defined as: SMR=10 log [E(s²)/E(m²)], where E(s²) is the energy of the synthetic speech and E(m²) is the energy of the background music. Since the energy of the synthetic speech would be a known value, the time-varying mixing gain α may be derived given an SMR. The time-varying mixing gain α may be implemented at a word level or a sentence level. Accordingly, a template function can be used to reshape the time-varying mixing gain α to, for example, fade-in when beginning a word and lift gain during a pause, such as between a paragraph or chapter in an audio book, as shown roughly in FIG. 4.

Thus, any computer readable text may be accompanied by emotionally appropriate background music. Accordingly, media such as electronic books, emails, SMS messages, games, etc. may be enhanced, not just by the addition of music, but rather by the addition of music that corresponds to the emotional tone expressed in the media. Additionally, since the addition of the music is automatic, and is performed at the mobile terminal 10, the labor intensive, time consuming and expensive process of tagging media for correlation to emotionally appropriate music can be avoided.

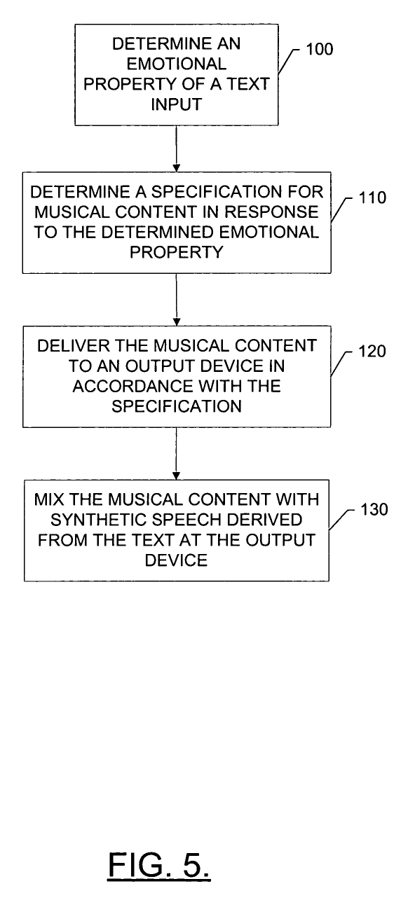

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for content dependent music mixing includes determining an emotional property of a text input at operation 100. At operation 110, a specification for musical content is determined in response to the emotional property. In an exemplary embodiment, determining the specification includes selecting the musical content from a group of musical elements that are arranged according to emotional properties. In another exemplary embodiment, determining the specification includes providing instructions to modify a pre-composed musical element according to the determined emotional property. At operation 120, musical content is delivered to an output device, such as an audio mixer or a speaker, in accordance with the specification. If the present invention is used in the context of enhancing a TTS system, then the musical content is mixed with synthetic speech derived from the text at operation 130. The mixed musical content and synthetic speech may then be synchronized to be played at the same time by an audio output device. Additionally, a mixing gain of the output device may be varied in response to timing instructions. In other words, the mixing gain may be time variable in accordance with predetermined criteria.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium. It should also be noted, that although the above described principles have been applied in the context of delivering background music related to emotional themes of text, similar principles would also apply to the delivery of background music related to emotional themes of other media including, for example, pictures. Additionally, the present invention should not be limited to presenting music related to an emotional theme of a first media content. Thus, a second media content such as a visual image may be displayed according to a specification determined based on the emotional content of the first media content, such as text.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of providing content dependent media content mixing, the method comprising:
automatically determining an emotional property of a first media content input;
determining a specification for a second media content in response to the determined emotional property; and
producing the second media content in accordance with the specification.

2. A method according to claim 1, wherein the second media content is musical content.

3. A method according to claim 2, wherein the first media content is text content.

4. A method according to claim 3, wherein determining the emotional property comprises dividing the text content into segments and determining by text analysis the emotional property associated with each of the segments.

5. A method according to claim 4, further comprising mixing the musical content with synthetic speech derived from the text content.

6. A method according to claim 2, wherein determining the specification comprises selecting the musical content from a group of musical elements that are associated with respective emotional properties.

7. A method according to claim 2, wherein determining the specification comprises providing instructions to modify a pre-composed musical element according to the determined emotional property.

8. A method according to claim 5, further comprising varying a mixing gain in response to timing based instructions.

9. A method according to claim 8, wherein the mixing gain is increased during pauses in the text content.

10. A method according to claim 1, wherein producing the second media content comprises one of:
generating music;
modifying a musical score; and
selecting an appropriate musical score.

11. A computer program product for providing content dependent media content mixing, the computer program product comprising at least one computer-readable storage medium having computer-readable program code portions stored therein, the computer-readable program code portions comprising:
a first executable portion for automatically determining an emotional property of a first media content input;
a second executable portion for determining a specification for a second media content in response to the determined emotional property; and
a third executable portion for producing the second media content in accordance with the specification.

12. A computer program product according to claim 11, wherein the second media content is musical content.

13. A computer program product according to claim 12, wherein the first executable portion further includes instructions for dividing a text into segments and determining by text analysis the emotional property associated with each of the segments.

14. A computer program product according to claim 13, further comprising fourth executable instruction for mixing the musical content with synthetic speech derived from the text.

15. A computer program product according to claim 12, wherein the second executable portion further includes instructions for selecting the musical content from a group of musical elements that are associated with respective emotional properties.

16. A computer program product according to claim 12, wherein the second executable portion further includes instructions for providing instructions to modify a pre-composed musical element according to the determined emotional property.

17. A computer program product according to claim 14, further comprising a fourth executable portion for varying a mixing gain in response to timing based instructions.

18. A computer program product according to claim 17, wherein the fourth executable portion further includes instructions for increasing the mixing gain during pauses in the text.

19. A computer program product according to claim 11, wherein third executable portion comprises one of:
generating music;
modifying a musical score; and
selecting an appropriate musical score.

20. A device for providing content dependent media content mixing, the device comprising:
a first module configured to automatically determine an emotional property of a first media content input; and
a second module configured to determine a specification for a second media content in response to the determined emotional property and producing the second media content in accordance with the specification.

21. A device according to claim 20, wherein the first module is a text content analyzer and the first media content is a text, and wherein the second module is a music module and the second media content is musical content.

22. A device according to claim 21, wherein the music module is capable of accessing musical elements associated with respective emotional properties.

23. A device according to claim 21, wherein the music module is capable of accessing at least one pre-composed musical element and the music module is further configured to modify the pre-composed musical element according to the determined property.

24. A device according to claim 21, wherein the text content analyzer is capable of dividing a text into segments and determining by text analysis the emotional property associated with each of the segments.

25. A mobile terminal for providing content dependent media content mixing, the mobile terminal comprising:
an output device capable of delivering media in a user perceptible manner;
a first module configured to automatically determine an emotional property of a first media content input; and
a second module configured to determine a specification for a second media content in response to the determined emotional property and produce the second media content in accordance with the specification.

26. A mobile terminal according to claim 25, wherein the first module is a text content analyzer and the first media content is a text, and wherein the second module is a music module and the second media content is musical content.

27. A mobile terminal according to claim 26, wherein the text content analyzer is capable of dividing a text into segments and determining by text analysis the emotional property associated with each of the segments.

28. A mobile terminal according to claim 26, wherein the output device is an audio mixer capable of mixing a plurality of audio signals.

29. A mobile terminal according to claim 28, wherein the audio mixer is configured to vary a mixing gain in response to timing based instructions.

30. A mobile terminal according to claim 29, the missing gain is increased during pauses in the text.

31. A mobile terminal according to claim 28, further comprising a text-to-speech module capable of producing synthetic speech responsive to the input text, the text-to-speech module delivering the synthetic speech to the audio mixer,
wherein the audio mixer mixes the synthetic speech and the musical content.

32. A mobile terminal according to claim 26, wherein the music module is capable of accessing musical elements associated with respective emotional properties.

33. A mobile terminal according to claim 26, wherein the music module is capable of accessing at least one pre-composed musical element and the music module is further configured to modify the pre-composed musical element according to the determined property.
